(19) United States
(12) Patent Application Publication
(10) Pub. No.: US 2021/0036516 A1
(43) Pub. Date: Feb. 4, 2021

(54) METHOD AND DATA PROCESSING CONFIGURATON FOR CONTROLLING POWER FLOW IN AN ELECTRICAL SUPPLY NETWORK

(71) Applicant: SIEMENS AKTIENGESELLSCHAFT, MUENCHEN (DE)

(72) Inventors: CHRISTIAN BLUG, QUIERSCHIED (DE); GERMAN KUHN, ERLANGEN (DE); ALEXANDER RENTSCHLER, BENSHEIM (DE); KUNAL SHARMA, ERLANGEN (DE); MAXIME DELZENNE, ERFURT (DE)

(21) Appl. No.: 16/944,424

(22) Filed: Jul. 31, 2020

(30) Foreign Application Priority Data
Aug. 1, 2019 (EP) 19189593

(51) Int. Cl. H02J 3/00; G05B 19/042

(52) U.S. Cl. CPC H02J 3/00; G05B 2219/2639; H02J 2203/20; G05B 19/042

(57) ABSTRACT

A method controls power flow in an electrical supply network. The method includes: providing at least one power flow control device, providing a model of the electrical supply network for estimating the distribution of the power flow in the electrical supply network in accordance with predefined network parameters, and simulating the power flow in the network using the model such that a potential congestion path in the electrical supply network is identified. As a result of the simulation, a positioning scheme for the at least one power flow control device is provided, such that congestion in the identified potential congestion path can be avoided. The at least one power flow device is configured in accordance with the positioning scheme. The power flow in the supply network is controlled by means of the at least one power flow control device.

### CROSS-REFERENCE TO RELATED APPLICATION

This application claims the priority, under 35 U.S.C. § 119, of European patent application EP 19189593, filed Aug. 1, 2019; the prior application is herewith incorporated by reference in its entirety.

### BACKGROUND OF THE INVENTION

### Field of the Invention

The invention relates to a method for controlling power flow in an electrical supply network.

As a result of new environmental legislation, rights-of-way issues, construction cost increases, deregulation policies and decentralized power generation, there is an increasing recognition of the necessity to utilize the existing transmission system assets to the maximum extent possible.

At the same time high penetration of decentralize renewable generation i.e. wind park based on environment condition, regulation policy of Transmission System Operators (TSO) and Distribution System Operators (DSO) make the operation of transmission system more challenging. In this context, TSOs are facing problems to control the power flow and secure the system efficiently and effectively with existing controller and operation methodology.

The power transmitted over an AC transmission line is a function of the line impedance, the magnitude of sending-end and receiving-end voltages, and the phase angle between these voltages. Traditional controller in transmission system like phase shifting transformers with mechanical tap-changer and fixed series capacitor are used to control power flow. A new generation of power flow controllers is given by universal power flow controllers (UPFC) containing two converters coupled to each other by their respective DC sides and connected to the AC network via their AC sides (known e.g. from the article “Comprehensive Power Flow Analyses and Novel Feedforward Coordination Control Strategy for MMC-based UPFC” by Liu et al., Energies 2019).

In current situation any grid is divided in different control areas based on certain agreement. Each control area in the grid must achieve balance between power supplied and power consumed. Control areas achieve this balance with the help of power sales and purchase using tie-lines between control areas. These transactions are normally scheduled in advance based on forecast load, the cost and availability of on-line generation and the capacity available on the transmission system. Further, to establish generous stability margins enabling the system to recover from faults, line and generator outages, and equipment failures results in a significant underutilization of the AC transmission system with current slow conventional controllers.

### SUMMARY OF THE INVENTION

The object of the invention is to propose an effective and reliable method for controlling power flow in an electrical supply network.

The object is achieved by a method for controlling power flow in an electrical supply network containing the steps of: providing a power flow control device, providing a model of the supply network for estimating the distribution of the power flow in the supply network in accordance with predefined network parameters, and simulating the power flow in the network using the model such that at least on potential congestion path in the supply network is identified. As a result of the simulation, a positioning scheme for the at least one power flow control device is provided, such that congestion in the identified potential congestion path can be avoided. The at least one power flow device is arranged in accordance with the positioning scheme, and the power flow in the supply network is controlled by means of the at least one power flow control device. The present invention is based on the finding that an optimal placement of the power flow control device in the supply network is very much essential in order to obtain the maximum possible efficiency and reliability for the power flow control. In accordance with the present invention, in order to find the best arrangement for the at least one power flow control device the supply network is simulated using a supply network model. The simulation considers possible placements of the one or more power flow control devices and correspondingly finds at least one potential congestion path or network line. The potential congestion path is given by a network path or line where a congestion is probable to occur under certain network conditions, e.g. in case of a fault or an overload. In this manner the at least one power flow device can be utilized in a most effective and reliable way, when arranged according to the positioning scheme provided by the simulation. The power flow control device can e.g. be placed directly in the potential congestion path but it may be in some cases more efficient to place the power flow control device in a network path which is underutilized in case of congestion in the network, as for example in a transmission line next to the potential congestion path.

The simulation is preferably carried out taking into consideration the placement of the power flow device within the supply network in order to determine an optimal power flow distribution in the supply network.

According to an embodiment of the invention the at least power flow control device is an UPFC. The UPFC contains e.g. a first and a second modular multilevel converter, wherein the converters are connected to each other by their respective dc sides wherein the ac side of each of the converters respectively is connected to a network line (transmission line) of the supply network. The UPFC contains preferably modular multilevel voltage sourced converters (MMC) with insulated gate bipolar transistors (IGBT) or other suitable disactivable semiconductor switches (like e.g. IGCT) that are arranged as rectifier at one end and inverter at the other end. Rectifier and inverter are interconnected with a DC link. The converter units are preferably connected to the AC line via shunt connection at one side and via in series connection at the other side. Preferably, transformers at both sides de-couple the system with DC link from the AC system and adapt the AC system voltage to required voltage level of the converters. In some applications, the power flow control device can be a static synchronous series compensator (SSSC) or any other series voltage control device with variable series impedance. The SSSC contains a voltage source converter coupled with a transformer which is connected in series with a transmission line.

The power flow control device, in particular a UPFC, can be simulated as an additional voltage vector Vc added to a line voltage Vs. The amplitude of Vc can be varied, the angle of Vc can be set to pi/2 with respect to the resulting vector Vs′=Vs+Vc. In this way, the UPFC is represented as a generalized synchronous voltage source.

According to another embodiment of the invention the at least one power flow control device is a PST. The PST is simulated as a predefined phase shift of a line voltage Vs, which is a simple and effective representation of the PST in the simulation.

In further embodiments one or more UPFCs and one or more PSTs are used at the same time, depending on the supply network configuration.

The simulation is preferably carried out using a mixed-integer linear programming (MILP) algorithm. In particular the MILP algorithm is employed to solve the optimization problem and to run the power flow calculation in the model network.

Preferably the model of the supply network is generated in accordance with information on the capacity of network lines of the supply network. The information can be provided directly by the DSO or the TSO and can contain information about congestion in various lines and/or information about underutilized lines.

The invention relates further to a data processing arrangement for controlling power flow in an electrical supply network.

The object of the invention is to propose such a data processing arrangement which allows an effective and reliable control of power flow in the network.

The object is achieved by a data processing arrangement containing a model generator for generating a model of the supply network, said model providing a power flow distribution in the supply network in accordance with predefined network parameters, and a simulation module for carrying out a simulation of the power flow in the modeled supply network such that at least on potential congestion path in the supply network is identified.

Other features which are considered as characteristic for the invention are set forth in the appended claims.

Although the invention is illustrated and described herein as embodied in a method for controlling power flow in an electrical supply network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a UPFC; and

FIG. 2 is a schematic view of an exemplary embodiment of a method according to the invention.

### DETAILED DESCRIPTION OF THE INVENTION

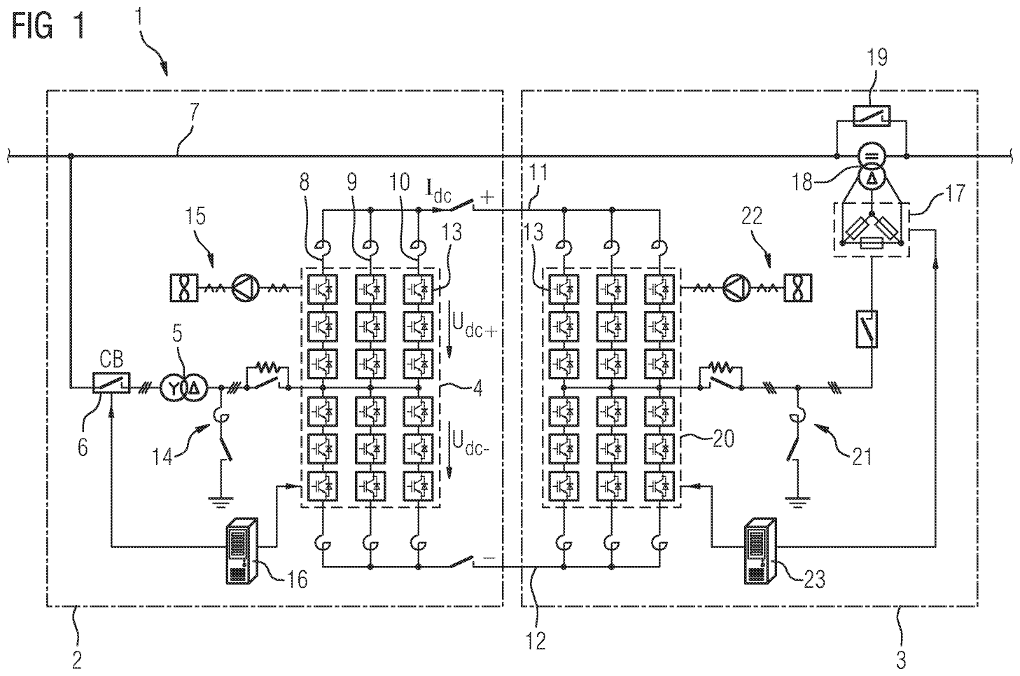

Referring now to the figures of the drawings in detail and first, particularly to FIG. 1 thereof, there is shown a universal power flow controller (UPFC) 1. The UPFC 1 contains a first converter unit 2 and a second converter unit 3. The first converter unit 2 has a first converter 4 which is connected via a transformer 5 and a shunt 6 in parallel to a three-phase network line 7. The first converter 4 is a so-called modular multilevel converter. It contains three parallel phase modules, wherein each of the phase modules 8-10 has two converter arms arranged between a respective AC connection and one of two DC poles 11 or 12. Every converter arm contains an arm choke and a series of submodules 13, wherein each submodule contains semiconductor switches and an energy storage, e.g. a capacitor. The semiconductor switches and the capacitor of the submodule are e.g. arranged to form a so-called half-bridge circuit, assembled to form a multilevel arrangement. Additionally, the first converter unit 2 contains a first star point reactor 14, a cooling system 15 and a control arrangement 16 configured to control and/or drive the shunt 6 and the switches of the submodules 13.

The second converter unit 3 contains a second converter 20 which is a modular multilevel converter similar to the first converter 4. The second converter 20 is on its AC side connected via a fast bypass device 17 and a transformer 18 to the network line 7. A bypass switch 19 is provided for bypassing the second converter 20. Moreover, the second converter unit 3 contains a second star point reactor 21, a cooling system 22 and a control arrangement 23 configured to control the switches of the submodules 13 and the fast bypass device 17.

The first and the second converter are connected to each other via their respective DC sides forming an intermediate DC link 11, 12.

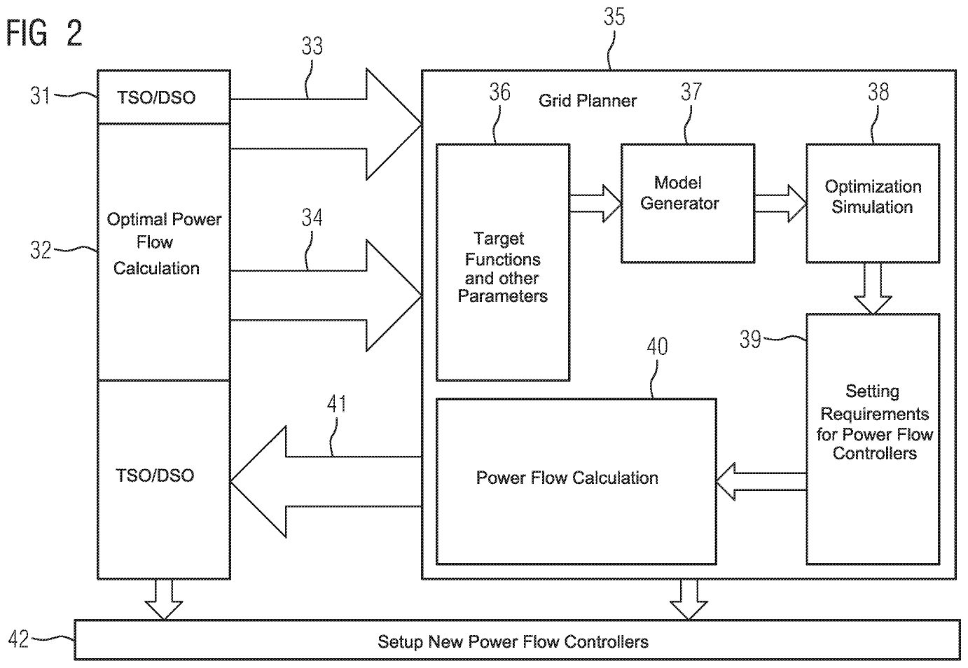

FIG. 2 shows an example of a method in accordance with the invention. The TSO or DSO 31 performs an optimal power flow calculation in block 32 in order to manage an operation planning and the necessary switching procedures. As an output of the calculations performed by the TSO/DSO it provides an information 33 about congestion in various lines of the corresponding supply network and an information 34 about underutilized lines in the network to a grid planner 35. The grid planner defines in a block 36 target functions and other parameters of planning. It also selects a number of power flow control devices such as UPFC or PST to be used for power flow control in the supply network. A model generator in block 37 uses the information provided by block 36 and the information from the TSO/DSO for a model setup using a mixed integer linear programming for modeling the power flow in the network. In block 38 the optimization simulation is run. Given the result of the simulation, in block 39 the solutions are provided concerning the setting and other requirements for the power flow controllers. In block 40 the power flow calculation is run in order to obtain a ranking of locations for the power flow control devices. Preferably a coordinated UPFC operation is taken into account in order to solve the problem of congestions in the network. As an output of the grid planner, an information 41 about the location and also about the operation methodology is provided to the DSO/TSO 31 where a new and improved power flow calculation can be performed based on the provided information. Additionally, the results are also provided in order to facilitate the setup of requirements of new power flow controllers by their respective manufacturers in block 42.

1. A method for controlling power flow in an electrical supply network, which comprise the steps of:
providing at least one power flow control device;
providing a model of the electrical supply network for estimating a distribution power flow in the electrical supply network in accordance with predefined network parameters;
simulating the power flow in the electrical supply network using the model such that at least one identified potential congestion path in the electrical supply network is identified, wherein, as a result of a simulation, a positioning scheme for the at least one power flow control device is provided, such that congestion in the at least one identified potential congestion path can be avoided;
configuring the at least one power flow control device in accordance with the positioning scheme; and
controlling the power flow in the electrical supply network by means of the at least one power flow control device.

2. The method according to claim 1, which further comprises carrying out the simulation taking into consideration a placement of the power flow control device within the electrical supply network in order to determine an optimal power flow distribution in the electrical supply network.

3. The method according to claim 1, wherein the at least power flow control device is an universal power flow controller (UPFC), a static synchronous series compensator (SSSC) or any other series voltage control device with variable series impedance.

4. The method according to claim 3, wherein the UPFC contains a first and a second modular multilevel converter, wherein the first and second modular multilevel converters are connected to each other by their respective DC sides and an AC side of each of the first and second modular multilevel converters is connected to a network line of the electrical supply network.

5. The method according to claim 3, wherein the power flow control device is simulated as an additional voltage vector of a line voltage.

6. The method according to claim 1, wherein the at least one power flow control device is a phase-shifting transformer (PST).

7. The method according to claim 6, wherein the PST is simulated as a predefined phase shift of a line voltage.

8. The method according to claim 1, wherein the simulation is carried out using a mixed-integer linear programming (MILP) algorithm.

9. The method according to claim 1, which further comprises generating the model of the electrical supply network in accordance with information on a capacity of network lines of the electrical supply network.

10. A data processing configuration for controlling power flow in an electrical supply network, the data processing configuration comprising:
a model generator for generating a modeled supply network of the electrical supply network, said modeled supply network providing a power flow distribution in the electrical supply network in accordance with predefined network parameters; and
a simulation module for carrying out a simulation of the power flow in the modeled supply network such that at least one identified potential congestion path in the electrical supply network is identified, wherein, as a result of the simulation, a positioning scheme for at least one power flow controller is provided, such that congestion in the at least one identified potential congestion path can be avoided.
